(19) United States
(12) Patent Application Publication
(10) Pub. No.: US 2024/0273308 A1
(43) Pub. Date: Aug. 15, 2024

(54) SYSTEM AND METHOD FOR VISUAL CONTENT GENERATION AND ITERATION

(71) Applicant: Toyota Research Institute, Inc., Los Altos, CA (US)

(72) Inventors: Alice X. Cai, Cambridge, MA (US); Thomas W. Malone, Boston, MA (US); Yanxia Zhang, Foster City, CA (US); Alexandre Filipowicz, Mountain View, CA (US); Matthew K. Hong, Mountain View, CA (US); Steven R. Rick, Cambridge, MA (US); Heishiro Toyoda, Mountain View, CA (US)

(73) Assignees: Toyota Research Institute, Inc., Los Altos, CA (US); Toyota Jidosha Kabushiki Kaisha, Toyota-shi Aichi-ken (JP); Massachusetts Institute of Technology, (omitted)

(21) Appl. No.: 18/498,380

(22) Filed: Oct. 31, 2023

Related U.S. Application Data
(60) Provisional application No. 63/445,181, filed on Feb. 13, 2023.

(51) Int. Cl. G06F 40/40

(52) U.S. Cl. CPC G06F 40/40

(57) ABSTRACT

Systems, methods, and other embodiments described herein relate to enhancing and complementing a creative process of a user that includes generating and iterating visual content with an emphasis on diverse design ideas. In one embodiment, a method includes generating a plurality of texts that are related and semantically diverse based on one or more prompts using a generative language model and generating a plurality of images based on at least a portion of the plurality of texts using a generative visual model.

### CROSS-REFERENCE TO RELATED APPLICATION

This patent application makes reference to, claims priority to, and claims benefit from U.S. Provisional Patent Application No. 63/445,181, titled “DesignAID: Using generative AI to avoid design fixation” filed on Feb. 13, 2023; which is hereby incorporated herein by reference in its entirety.

### TECHNICAL FIELD

The subject matter described herein relates, in general, to systems and methods for visual content generation and iteration.

### BACKGROUND

Machine learning models are useful in generating data. Machine learning models may generate data based on prompts. However, the machine learning models have a limited ability to generate data that may be contextually diverse based on a prompt.

### SUMMARY

In one embodiment, a system for enhancing and complementing a creative process of a user that includes generating and iterating visual content with an emphasis on diverse design ideas is disclosed. The system includes a processor and a memory in communication with the processor. The memory stores machine-readable instructions that, when executed by the processor, cause the processor to generate a plurality of texts that are related and semantically diverse based on one or more prompts using a generative language model and generate a plurality of images based on at least a portion of the plurality of texts using a generative visual model.

In another embodiment, a method for enhancing and complementing a creative process of a user that includes generating and iterating visual content with an emphasis on diverse design ideas is disclosed. The method includes generating a plurality of texts that are related and semantically diverse based on one or more prompts using a generative language model and generating a plurality of images based on at least a portion of the plurality of texts using a generative visual model.

In another embodiment, a non-transitory computer-readable medium for enhancing and complementing a creative process of a user that includes generating and iterating visual content with an emphasis on diverse design ideas is disclosed. The non-transitory computer-readable medium includes instructions that, when executed by a processor, cause the processor to generate a plurality of texts that are related and semantically diverse based on one or more prompts using a generative language model and generate a plurality of images based on at least a portion of the plurality of texts using a generative visual model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a data flow of a visual content generation system.

FIG. 2 illustrates another example of a data flow of the visual content generation system.

FIG. 3 illustrates an example of a data flow of the visual content generation system in a direct input mode.

FIG. 4 illustrates one embodiment of the visual content generation system.

FIG. 5 is a flowchart illustrating one embodiment of a method associated with visual content generation.

### DETAILED DESCRIPTION

Systems, methods, and other embodiments associated with systems and methods for visual content generation and iteration are disclosed. Designing visual and physical objects can be challenging. The start of a visual design process may include imaginative exploration of a broad landscape of possible designs. However, users may face difficulty in fully engaging in imaginative exploration because of design fixation. Design fixation is a tendency for a user to become focused on a limited set of solutions to a problem. Combining design fixation with humans' natural tendency to ideate around ideas that are already familiar may lead to prematurely converging on suboptimal solutions in place of broadly exploring a larger space of possibilities. However, even when a user explores a large space of possibilities, manually capturing and/or recording the visual ideas may be labor-intensive, time-consuming, and costly.

Current methods for addressing design fixation include prevention methods such as the user applying concept mapping, remote association, deliberate exposure to new and unrelated content, and crowd-based diversity ratings. However, these methods rely heavily on human effort and knowledge resources. Current methods may include selecting visual content and images from databases with a collection of images such as Google Images™ and Pinterest™. However, these methods are limited as the aforementioned databases include already existing visual content. Current methods may include generative visual models such as Adobe® Firefly™, StabilityAI™, and Midjourney™. However, the generative visual models alone are unable to generate and facilitate divergent thinking.

Accordingly, systems, methods, and other embodiments associated with enhancing and complementing a user's creative process for generating and iterating visual content with an emphasis on diverse design ideas based on maximizing distances between semantic embeddings of artificial intelligence (AI)-generated ideas are disclosed. The creative process may include exploring new visual designs and/or refining or finetuning the visual design. The use of generative AI tools to assist users designing visual and physical objects is disclosed.

The embodiments disclosed assist users in the creation and selection of design ideas and visual representation of the design ideas. The methods disclosed include the creation of diverse design ideas based on maximizing distances between semantic embeddings of AI-generated ideas.

The systems disclosed include a generative AI tool that assists users during the early stages of a creative design process such as gathering inspiration and developing ideas. More specifically and as an example, the system may include a generative language model, a selection model, and a generative visual model. The generative language model is trained to generate a set of related but semantically diverse texts based on one or more prompts. The selection model is trained to receive the set of related but semantically diverse texts and select the most semantically diverse texts from the set of related but semantically diverse texts. The generative visual model is trained to receive the most semantically diverse texts and generate visual images corresponding to the most semantically diverse texts.

The system may operate in one of two modes—low-diversity (Direct Input) and high-diversity (New Ideas). In the low-diversity mode, the system or, more specifically, the generative visual model receives one or more prompts from a user and outputs images based on the prompt(s). As such, in the low-diversity mode, the system and the generative visual model generate images based on and directly in response to the prompt(s).

In the high-diversity mode, the system or more specifically, the generative language model receives one or more prompts from a user and generates a set of related but semantically diverse texts. The system or, more specifically, the selection model receives the set of related but semantically diverse texts and selects a set of the most semantically diverse texts from the set of related but semantically diverse texts. Then, the system or, more specifically, the generative visual model receives the set of the most semantically diverse texts and generates images based on the set of the most semantically diverse texts. As an example, the generative visual model may generate an image that corresponds to each text in the set of the most semantically diverse texts.

In addition to the system generating new ideas as detailed above when the system is in a low-diversity mode or in a high diversity mode, the system may operate in a refinement mode or convergent mode. In the refinement mode, the system may receive an image previously generated by the generative visual model. As an example, the system or more specifically, the generative language model may receive the image and generate a set of related but semantically diverse texts based on at least the image. Then, the system or, more specifically, the generative visual model receives at least a portion of the set of related but semantically diverse texts and generates images based on the portion of the set of related but semantically diverse texts.

As another example, the system or more specifically, the generative visual model may generate a first image and receive the first image as a prompt. The system or more specifically, the generative visual model may generate a second image based on at least the first image. As such, the system may refine the features of the images using such an iterative process.

The embodiments disclosed herein present various advantages over conventional technologies for visual content generation and iteration. One advantage includes assisting users in overcoming design fixation. Another advantage includes providing novel, diverse, and inspirational content. Another advantage includes providing a wide range of ideas. Another advantage includes reducing the time, labor, and cost spent by the user when the user is generating new visual design. Another advantage includes the system having a short turnaround time, and as such, the user is able to quickly iterate through ideas and identify the ideas to be explored and refine further. Another advantage includes providing semantic diversity and a more diverse set of images.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

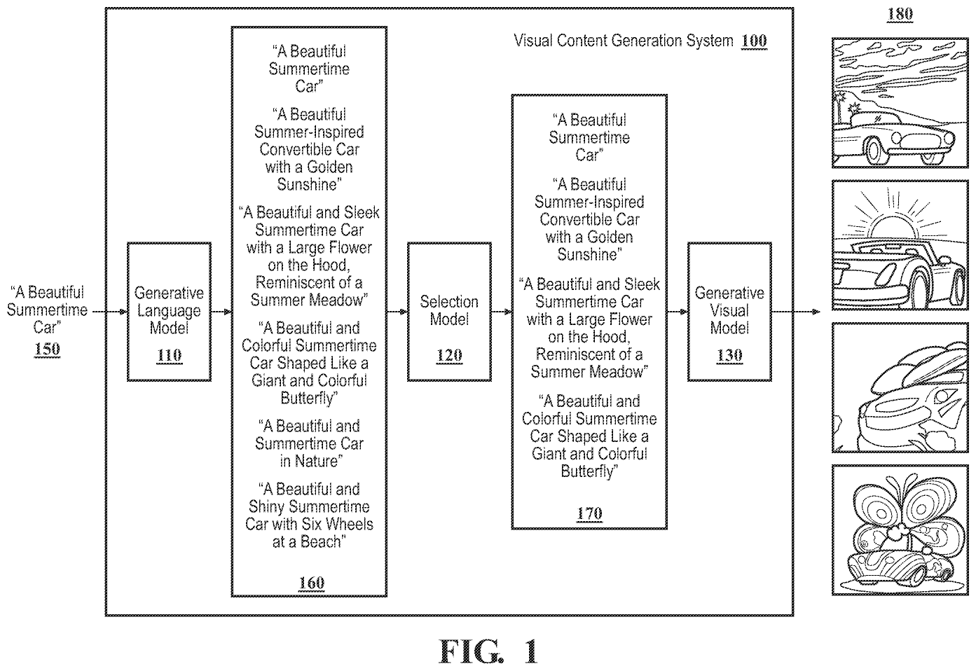

FIG. 1 illustrates an example of a data flow of a visual content generation system 100. The visual content generation system 100 may include various elements, which may be communicatively linked in any suitable form. As an example, the elements may be connected, as shown in FIG. 1. Some of the possible elements of the visual content generation system 100 are shown in FIG. 1 and will now be described. It will be understood that it is not necessary for the visual content generation system 100 to have all the elements shown in FIG. 1 or described herein. The visual content generation system 100 may have any combination of the various elements shown in FIG. 1. Further, the visual content generation system 100 may have additional elements to those shown in FIG. 1. In some arrangements, the visual content generation system 100 may not include one or more of the elements shown in FIG. 1.

The visual content generation system 100 may include one or more generative language models 110. Generative models are a class of machine learning models that can generate new data based on training data. As such, the generative language model 110 can generate new ideas in a text format. The generative language model(s) 110 may include any suitable machine learning models such as Generative Pre-trained Transformer (GPT), e.g., OpenAI's GPT-3. GPT is a large language model that attempts to predict subsequent texts when given an initial textual prompt.

The visual content generation system 100 and/or a user may train the generative language model 110 on how to generate new ideas based on one or more prompts 150. As an example, the visual content generation system 100 may provide various prompts as well as the types of new ideas to generate in response to the various prompts. The generative language model 110 may receive various inputs from a user such as one or more prompts, instructions to generate new ideas, a number of new ideas, the diversity between the new ideas, any other suitable constraints, and/or examples of the types of new ideas to generate. The one or more prompts 150 may be in any suitable format. As an example, the one or more prompts 150 may be in the form of a text, an image, a sound and/or a video. The one or more prompts 150 may be a combination of text, image, sound, and/or video. The text may be one or more words. As such, the text may be a single word, a string of words, a phrase, a sentence, paragraph or even longer. In general, the prompts 150, including texts, images, sounds, and/or videos, may be of any suitable size.

The prompts 150 may be machine generated prompts, human generated prompts, or a combination of machine generated prompts and human generated prompts. Machine generated prompts may refer to prompts or data generated by a generative model. Human generated prompts refers to prompts that have been created by a human user. In general, a user may select any suitable combination of prompts 150 that include prompts created by the user and/or prompts selected by the user from various sources such as databases and/or generative models. The user may select an output of a generative model as a prompt into the same generative model. Alternatively and/or additionally, the user may select prompts generated by other generative models. As an example, the generative language model 110 may receive as a prompt 150 the output image 180 of a generative visual model 130.

The generative language model 110 may generate a plurality of texts 160 that are related and semantically diverse. In other words, the generative language model 110 may output a set of semantically diverse texts 160 that are related to the prompt(s) 150 but differ from each other in terms of semantics or in terms of context. As shown in FIG. 1, the generative language model 110 may generate the plurality of semantically diverse texts 160 based on a prompt 150. In that example, the semantically diverse texts 160 are related to the prompt 150 as each of the semantically diverse texts 160 describes “a beautiful summertime car.” However, the semantically diverse texts 160 are semantically different as the semantically diverse texts 160 differ in context. As an example and as shown in FIG. 1, some texts describe the type of car, e.g., “ . . . convertible car . . . ”, “ . . . car with six wheels . . . ”, some texts describe the shape of the car, e.g., “ . . . large flower on the hood . . . ”, “ . . . shaped like a giant and colorful butterfly”, and other texts describe a location of the car, e.g., “ . . . in nature”, “ . . . at a beach”.

The visual content generation system 100 may include one or more selection models 120. The selection model(s) 120 may be any suitable machine learning models such as Google's Universal Sentence Encoder. The selection model 120 may be configured to select the most semantically diverse set of texts 170 from the semantically diverse texts 160 generated by the generative language model 110.

As an example, to select the most semantically diverse set of texts 170, the selection model 120 may be trained to generate a multi-dimensional vector space. The various dimensions of the multi-dimensional vector space correspond to different features or attributes of the semantically diverse text 160, such as context, syntactic role, and semantic properties. The selection model 120 may use any suitable language model(s) to map the semantically diverse text 160, as words and/or as phrases, into vectors in the multi-dimensional vector space. The selection model 120 may then determine the measure of semantic diversity between the semantically diverse texts 160 and select the most semantically diverse set of texts 170, which include the texts with the highest semantic diversity. In general, the selection model 120 may apply any suitable semantic embedding calculations to select the most semantically diverse set of texts 170.

The visual content generation system 100 may include one or more generative visual models 130. The generative visual model(s) 130 may be any suitable machine learning model such as DALL-E or a Stable Diffusion model. The generative visual model(s) 130 may be configured to generate images based on a prompt such as a textual prompt or an image prompt. As shown in FIG. 1, the generative visual model(s) 130 may be configured to generate a plurality of images 180 based on the most semantically diverse set of texts 170. Additionally and/or alternatively, the generative visual model(s) 130 may generate the images 180 based on all the semantically diverse texts 160. In general, the generative visual model 130 may generate the images 180 based on at least a portion of the semantically diverse texts 160.

In one embodiment, the generative visual model(s) 130 may generate new images 180 that did not previously exist based on the most semantically diverse set of texts 170 or the semantically diverse texts 160. Additionally and/or alternatively, the generative visual model(s) 130 may select and retrieve already existing images from one or more sources such as image databases. The generative visual model(s) 130 may select the already existing images based on at least the most semantically diverse set of texts 170 or the semantically diverse texts 160.

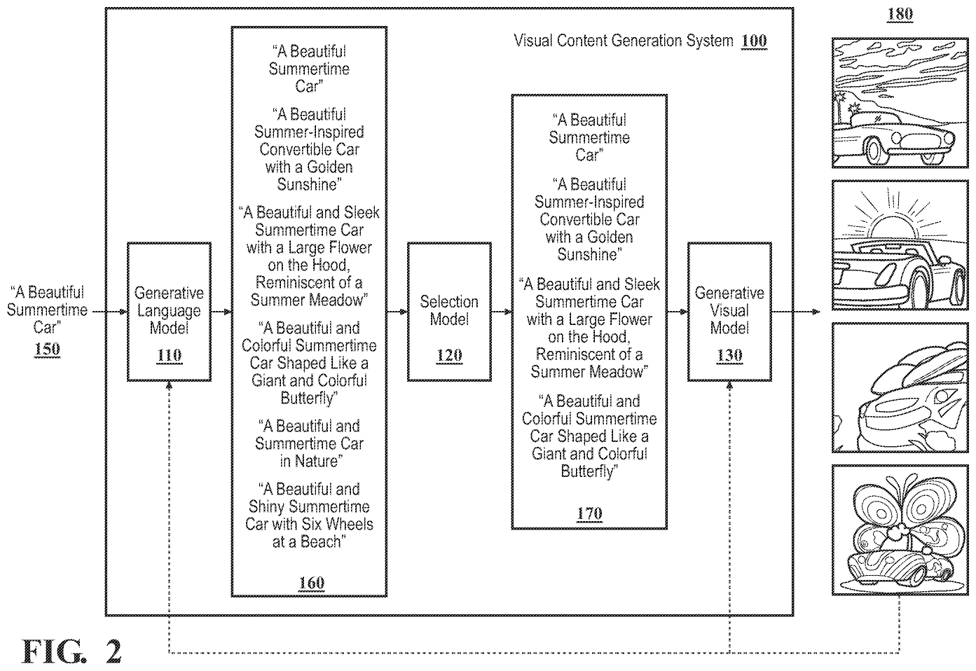

FIG. 2 illustrates another example of a data flow of the visual content generation system. As shown and as previously mentioned, the generative language model 110 may receive at least one of the images 180 as a prompt and may generate the semantically diverse texts based on at least one of the images 180 as a prompt. Additionally and/or alternatively, the generative visual model 130 may receive at least one of the images 180 as a prompt and may generate a next set of the images 180 based on at least one of the images 180 as a prompt. The generative visual model 130 may be configured to weight or bias prompts so as to skew and refine the resulting images.

In one embodiment, the generative visual model(s) 130 may generate a next set of new images 180 that did not previously exist based on images 180 the generative visual model(s) 130 previously generated in addition to the most semantically diverse set of texts 170 or the semantically diverse texts 160. Additionally and/or alternatively, the generative visual model(s) 130 may select and retrieve already existing images from one or more sources such as image databases. The generative visual model(s) 130 may select the already existing images based on at least the images 180 the generative visual model(s) 130 previously generated and the most semantically diverse set of texts 170 or the semantically diverse texts 160.

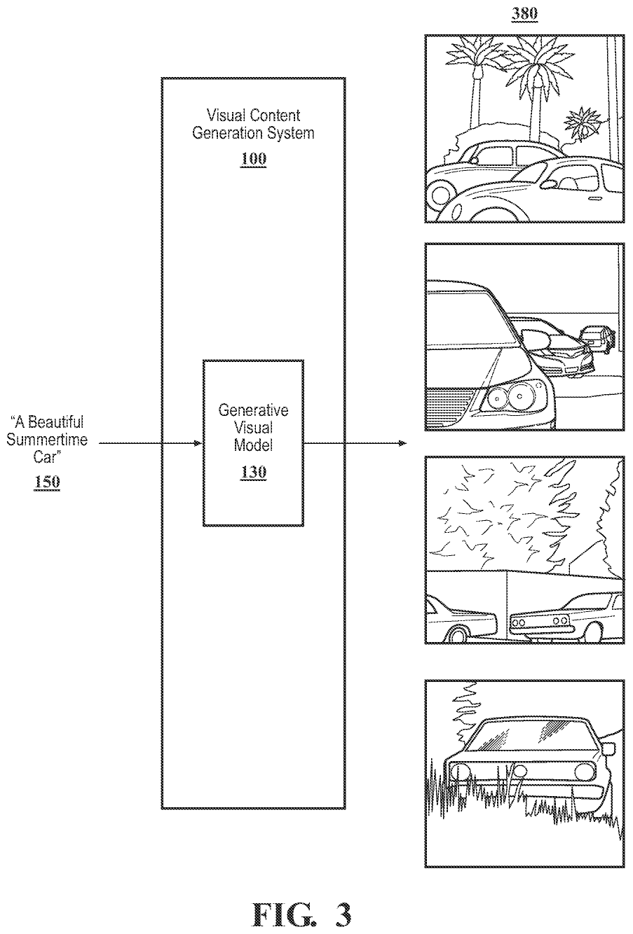

FIG. 3 illustrates an example of a data flow of the visual content generation system in a low diversity or direct input mode. As shown and as an example, the visual content generation system 100 includes the generative visual model 130. In this example, the generative visual model 130 receives a prompt 150 in the form of text and generates images 380 based on the prompt 150. More generally, the prompt 150 may be in any suitable format such as text, audio, visual, and/or video. The generative visual model 130 may receive one or more prompts 150 and generate images 380 based on the prompt(s) 150.

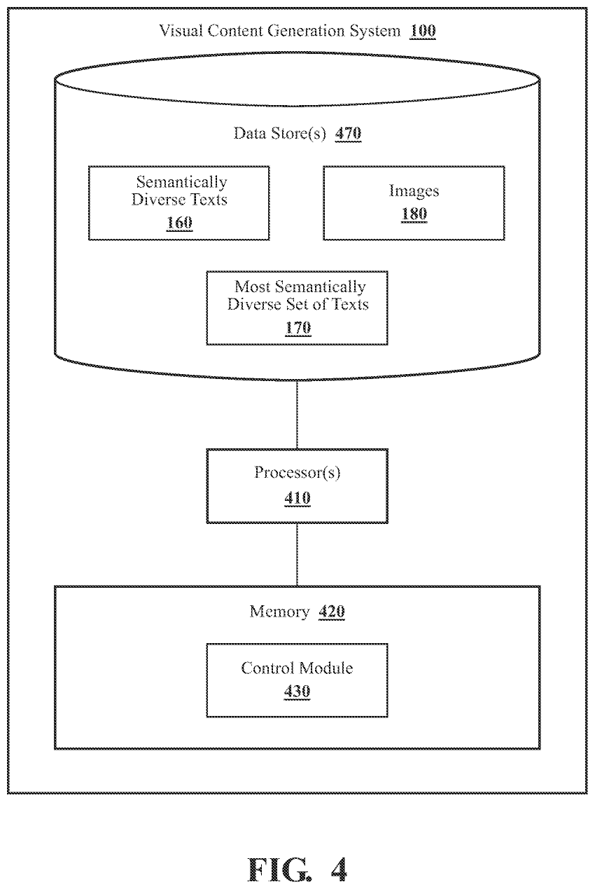

With reference to FIG. 4, one embodiment of the visual content generation system 100 of FIGS. 1-3 is further illustrated. The visual content generation system 100 is shown as including a processor 410. Accordingly, the processor 410 may be a part of the visual content generation system 100, or the visual content generation system 100 may access the processor 410 through a data bus or another communication path. In one or more embodiments, the processor 410 is an application-specific integrated circuit (ASIC) that is configured to implement functions associated with a control module 430. In general, the processor 410 is an electronic processor, such as a microprocessor, that is capable of performing various functions as described herein.

In one embodiment, the visual content generation system 100 includes a memory 420 that stores the control module 430 and/or other modules that may function in support of generating and iterating visual content. The memory 420 is a random-access memory (RAM), read-only memory (ROM), a hard disk drive, a flash memory, or another suitable memory for storing the control module 430. The control module 430 is, for example, machine-readable instructions that, when executed by the processor 410, cause the processor 410 to perform the various functions disclosed herein. In further arrangements, the control module 430 is a logic, integrated circuit, or another device for performing the noted functions that includes the instructions integrated therein.

Furthermore, in one embodiment, the visual content generation system 100 includes a data store 470. The data store 470 is, in one arrangement, an electronic data structure stored in the memory 420 or another data store, and that is configured with routines that can be executed by the processor 410 for analyzing stored data, providing stored data, organizing stored data, and so on. Thus, in one embodiment, the data store 470 stores data used by the control module 430 in executing various functions.

For example, as depicted in FIG. 4, the data store 470 includes plurality of semantically diverse texts 160, the most semantically diverse set of texts 170, and the images 180, along with, for example, other information that is used and/or produced by the control module 430. As previously described, the generative language model 110 outputs the plurality of semantically diverse texts 160 based on one or more prompts 150, the selection model 120 receives the plurality of semantically diverse texts 160 and outputs the most semantically diverse set of texts 170 based on the plurality of diverse texts 160, and the generative visual model 130 receives at least the most semantically diverse set of texts 170 as prompt(s) and outputs images 180 based on at least the most semantically diverse set of texts 170.

While the visual content generation system 100 is illustrated as including the various data elements, it should be appreciated that one or more of the illustrated data elements may not be included within the data store 470 in various implementations and may be included in a data store that is external to the visual content generation system 100. In any case, the visual content generation system 100 stores various data elements in the data store 470 to support functions of the control module 430.

In one embodiment, the control module 430 includes instructions that, when executed by the processor(s) 410, cause the processor(s) 410 to generate a plurality of texts 160 that are related and semantically diverse to one or more prompts 150 using a generative language model 110. In one or more arrangements, the prompts 150 may include at least one of a text, an image, a sound, and/or a video. As previously disclosed, the prompts 150 may be based on machine-generated data and/or human-generated data. The generative language model 110 may be any suitable generative language model such as GPT-3, ChatGPT, and LLaMA. The control module 430 may train the generative language model 110 using various prompts as well as the expected outputs such that the generative language model 110 may be configured to receive the prompts 150 and output or generate a set of texts 160 that are related and semantically diverse based on the prompts 150.

In one embodiment, the control module 430 includes instructions that, when executed by the processor(s) 410, cause the processor(s) 410 to generate a plurality of images 180 based on at least a portion of the plurality of texts 160 using a generative visual model 130. More generally, the control module 430 may generate the images 180 based on the portion of the semantically diverse texts 160 using the generative visual model 130. The portion of the semantically diverse texts 160 may be based on the most semantically diverse selection of the texts 170. In other words, the control module 430 may select the most semantically diverse set of texts 170 from the semantically diverse texts 160 using the selection model 120, and then, the control module 430 may generate the images 180 based on the most semantically diverse set of texts 170 using the generative visual model 130. Additionally and/or alternatively, the control module 430 may receive at least one image into the generative visual model 130 and may generate the images 180 using the generative visual model 130 based on at least the portion of the semantically diverse texts 160 and the image(s). The image may be user-generated and may be inputted as a prompt into the generative visual model 130. Additionally and/or alternatively, the image may be machine-generated and may be from a database or the same or another generative visual model.

The generative visual model 130 may be any suitable generative language model such as DALL-E and a Stable Diffusion model. The control module 430 may train the generative visual model 130 using various prompts as well as the expected outputted images such that the generative visual model 130 may be configured to receive semantically diverse texts 160 and output or generate images based on the semantically diverse texts 160. The control module 430 may refine the images 180 being outputted by the generative visual model 130 by selecting one or more images 180 outputted by the generative visual model and feeding the selected image(s) 180 back into the generative visual model 130. The control module 430 may select the image(s) 180 based on human input and/or any suitable algorithm such as a machine learning method or an artificial intelligence process. The control module 430 may apply weights to the selected image(s) 180 and the semantically diverse texts 160 being fed into the generative visual model 130. As an example, the control module 430 may apply a higher weight to an input image being fed into the generative visual model 130 and the generative visual model 130 may output images 180 that are skewed or biased toward the input image with the higher weighting. The control module 430 may determine the weights based on human input and/or any suitable algorithm such as a machine learning method or an artificial intelligence process.

The control module 430 may configure the generative visual model 130 to output new images 180 created by the generative visual model 130 and/or already existing images. The control module 430 may control the generative visual model 130 to select the already existing images from, as an example, a database, based on at least one of the semantically diverse texts 160 and the images generated by the generative visual model 130.

The control module 430 may output the images 180 from the generative visual model to a display screen and/or a data storage location such as a database. As an example, the control module 430 may output all the images 180 to the display screen and/or the data storage location. As another example, the control module 430 may output a portion of the images 180 to the display screen and/or the data storage location. The control module 430 may select the portion of the images 180 based on human input and/or any suitable algorithm such as a machine learning method or artificial intelligence process.

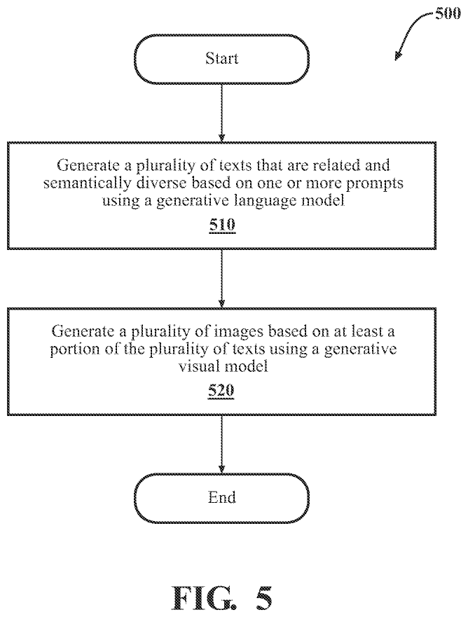

FIG. 5 is a flowchart illustrating one embodiment of a method 500 associated with visual content generation and iteration. The method 500 will be described from the viewpoint of the visual content generation system 100 of FIGS. 1-4. However, the method 500 may be adapted to be executed in any one of several different situations and not necessarily by the visual content generation system 100 of FIGS. 1-4.

At step 510, the control module 430 may cause the processor(s) 410 to generate a plurality of texts 160 that are related and semantically diverse to one or more prompts 150 using a generative language model 110.

At step 520, the control module 430 may cause the processor(s) 410 to generate a plurality of images 180 based on at least a portion of the plurality of texts 160 using a generative visual model 130. The control module 430 may select the most semantically diverse set of texts 170 from the plurality of the texts 160 using a selection model 120. The control module 430 may then generate the plurality of images 180 based on the most semantically diverse set of texts 170. The control module 430 may then output the plurality of images 180 to a user in any suitable format such as displaying the plurality of images 180 on a display screen, and/or storing the plurality of images 180 in a memory or a database.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having.” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
generate a plurality of texts that are related and semantically diverse based on one or more prompts using a generative language model; and
generate a plurality of images based on at least a portion of the plurality of texts using a generative visual model.

2. The system of claim 1, wherein the one or more prompts include at least one of:
a text;
an image;
a sound; or
a video.

3. The system of claim 1, wherein the one or more prompts are based on at least one of:
machine-generated data; or
human-generated data.

4. The system of claim 1, wherein the one or more prompts are based on at least one of the plurality of images.

5. The system of claim 1, wherein the machine-readable instructions further include instructions that when executed by the processor cause the processor to:
generate the plurality of images based on at least an image.

6. The system of claim 1, wherein the portion of the plurality of texts is based on a diverse selection of the plurality of texts.

7. The system of claim 1, wherein the plurality of images includes at least one of:
new images created by the generative visual model; or
already existing images selected based on the generative visual model.

8. A method comprising:
generating a plurality of texts that are related and semantically diverse based on one or more prompts using a generative language model; and
generating a plurality of images based on at least a portion of the plurality of texts using a generative visual model.

9. The method of claim 8, wherein the one or more prompts include at least one of:
a text;
an image;
a sound; or
a video.

10. The method of claim 8, wherein the one or more prompts are based on at least one of:
machine-generated data; or
human-generated data.

11. The method of claim 8, wherein the one or more prompts are based on at least one of the plurality of images.

12. The method of claim 8, further comprising:
generating the plurality of images based on at least an image.

13. The method of claim 8, wherein the portion of the plurality of texts is based on a diverse selection of the plurality of texts.

14. The method of claim 8, wherein the plurality of images includes at least one of:
new images created by the generative visual model; or
already existing images selected based on the generative visual model.

15. A non-transitory computer-readable medium including instructions that when executed by a processor cause the processor to:
generate a plurality of texts that are related and semantically diverse to one or more prompts using a generative language model; and
generate a plurality of images based on at least a portion of the plurality of texts using a generative visual model.

16. The non-transitory computer-readable medium of claim 15, wherein the one or more prompts include at least one of:
a text;
an image;
a sound; or
a video.

17. The non-transitory computer-readable medium of claim 15, wherein the one or more prompts are based on at least one of:
machine-generated data; or
human-generated data.

18. The non-transitory computer-readable medium of claim 15, wherein the one or more prompts are based on at least one of the plurality of images.

19. The non-transitory computer-readable medium of claim 15, wherein the instructions further include instructions that when executed by the processor cause the processor to:
generate the plurality of images based on at least an image.

20. The non-transitory computer-readable medium of claim 15, wherein the portion of the plurality of texts is based on a diverse selection of the plurality of texts.
